(19) United States
(12) Patent Application Publication
(10) Pub. No.: US 2008/0186912 A1
(43) Pub. Date: Aug. 7, 2008

(54) Method, apparatus, system, computer program product and computer program distribution medium for data transfer

(76) Inventor: Miikka Huomo, Espoo (FI)

Correspondence Address: HOLLINGSWORTH & FUNK, LLC;Attorneys at Law, Suite 125, 8009 34th Avenue South, Minneapolis, MN, 55425, US

(21) Appl. No.: 11/788,625

(22) Filed: Apr. 20, 2007

(30) Foreign Application Priority Data
Feb. 1, 2007 (FI) 20075062

(51) Int. Cl. H04Q 7/00

(52) U.S. Cl. 370/329

(57) ABSTRACT

A method for maintaining data transfer includes detecting user device inactivity in a communications system; releasing a user connection to a core network element for saving resources; and maintaining a user data service for enabling data transfer from the core network element via a radio network element to a user device.

### FIELD

The invention relates to a method, apparatus, system, computer program product and computer program distribution medium.

### BACKGROUND

In modern communication systems, packet-switched traffic is becoming more and more important. Delivery of digital data over mobile networks as well as Internet Protocol-based (IP-based) person-to-person communication combining different media and services into the same session increases the use of packet-switched services.

High Speed Packet Access, HSPA, is able to provide high data rate transmission to support multimedia services. HSPA brings high-speed data delivery to 3rd generation (3G) terminals. HSPA includes High Speed Downlink Packet Access (HSDPA) and High Speed Uplink Packet Access (HSUPA).

Internet-HSPA (I-HSPA) refers to a concept that uses the 3rd Generation Partnership Project (3GPP) HSPA air interface standard, but I-HSPA uses a simpler network architecture that is flatter than the architecture originally outlined in 3GPP. I-HSPA architecture may utilize a gateway general packet radio service (GPRS) support node (GGSN) using a GPRS tunneling protocol (GTP) or Mobile Internet Protocol with a home agent. One, and perhaps the main, difference between I-HSPA and the standard architecture outlined in 3GPP is that, in I-HSPA, radio network controller (RNC) functionalities are typically located in an I-HSPA unit in Node B.

One problem in designing I-HSPA relates to integration of radio network controller functionalities with Node B functionalities: due to the integration, core network elements have to control frequent Node B changes when a user device is moving.

### BRIEF DESCRIPTION OF THE INVENTION

According to an aspect of the invention, there is provided a method comprising, detecting user device inactivity in a communications system; releasing a user connection to a core network element for saving resources; and maintaining (206) a user data service for enabling data transfer from the core network element via a radio network element to a user device.

According to another aspect of the invention, there is provided an apparatus configured to: detect user device inactivity in a communications system; release a user connection to a core network element for saving resources; and maintain a user data service for enabling data transfer from the core network element via a radio network element to a user device.

According to another aspect of the invention, there is provided a system configured to: detect user device inactivity; release a user connection to a core network element for saving resources; and maintain a user data service for enabling data transfer from the core network element via a radio network element to a user device.

According to another aspect of the invention, there is provided an apparatus, comprising: means for detecting user device inactivity in a communications system; means for releasing a user connection to a core network element for saving resources; and means for maintaining a user data service for enabling data transfer from the core network element via a radio network element to a user device.

According to another aspect of the invention, there is provided a system, comprising: means for detecting user device inactivity; means for releasing a user connection to a core network element for saving resources; and means for maintaining a user data service for enabling data transfer from the core network element via a radio network element to a user device.

According to another aspect of the invention, there is provided a computer program product encoding a computer program of instructions for executing a computer process for data transmission, the process comprising: detecting user device inactivity in a communications system; releasing a user connection to a core network element for saving resources; and maintaining a user data service for enabling data transfer from the core network element via a radio network element to a user device.

According to another aspect of the invention, there is provided a computer program distribution medium readable by a computer and encoding a computer program of instructions for executing a computer process for data transmission, the process comprising: detecting user device inactivity; releasing a user connection to a core network element for saving resources; and maintaining a user data service for enabling data transfer from the core network element via a radio network element to a user device.

The invention provides several advantages.

An embodiment of the invention economizes the use of network resources especially when a user device is moving.

### LIST OF DRAWINGS

In the following, the invention will be described in greater detail with reference to embodiments and the accompanying drawings, in which

FIG. 1 shows an example of a communications system;

FIG. 2 is a flowchart;

FIGS. 3A to 3D illustrate examples of messaging, and

FIG. 4 shows an example of a radio network element.

### DESCRIPTION OF EMBODIMENTS

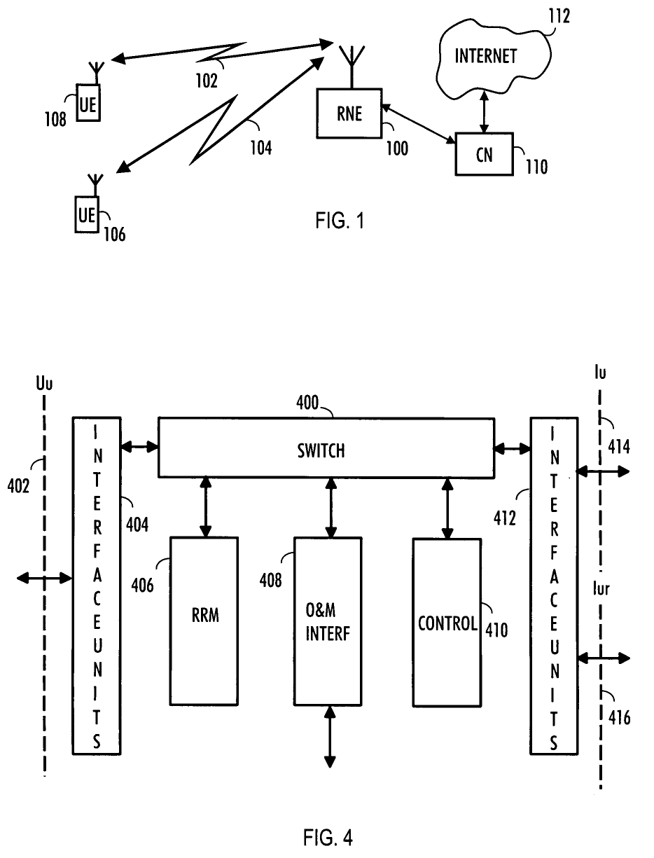

With reference to FIG. 1, we examine an example of a communications system to which embodiments of the invention can be applied. The present invention can be applied to communication systems offering HSDPA services. One example of such a communication system is the Universal Mobile Telecommunications System (UMTS) radio access network (UTRAN). It is a radio access network which includes wideband code division multiple access (WCDMA) technology and can also offer real-time circuit and packet switched services. The embodiments are not, however, restricted to the systems given as examples but a person skilled in the art may apply the solution to other communication systems.

FIG. 1 is a simplified illustration of a communications system to which embodiments according to the invention are applicable. This is a part of a cellular radio system which comprises a radio network element 100 into which functionalities of a base station and a radio network controller are integrated. The communications network may include separate base stations and radio network controllers, but in this example the part of the network is depicted as its simplest.

The radio network controller has bi-directional radio links 102 and 104 to user devices 106 and 108. The user devices may be fixed, vehicle-mounted or portable. The radio network element includes transceivers, for instance. From the transceivers of the radio network element a connection is provided to an antenna unit that establishes bi-directional radio links to the user devices.

The radio network element is further connected to a core network 110 (CN). The counterpart on the CN side can be a media gateway (MGW) or a serving GPRS (General Packet Radio Service) support node (SGSN), etc.

The communication system is also able to communicate with other networks, such as the Internet 112.

High Speed Downlink Packet Access (HSDPA) is designed to improve communications network capacity and increase user data rates in the downlink. The main target is to support multimedia services. HSDPA offers a possibility to adapt modulation scheme and coding to the quality of a radio link.

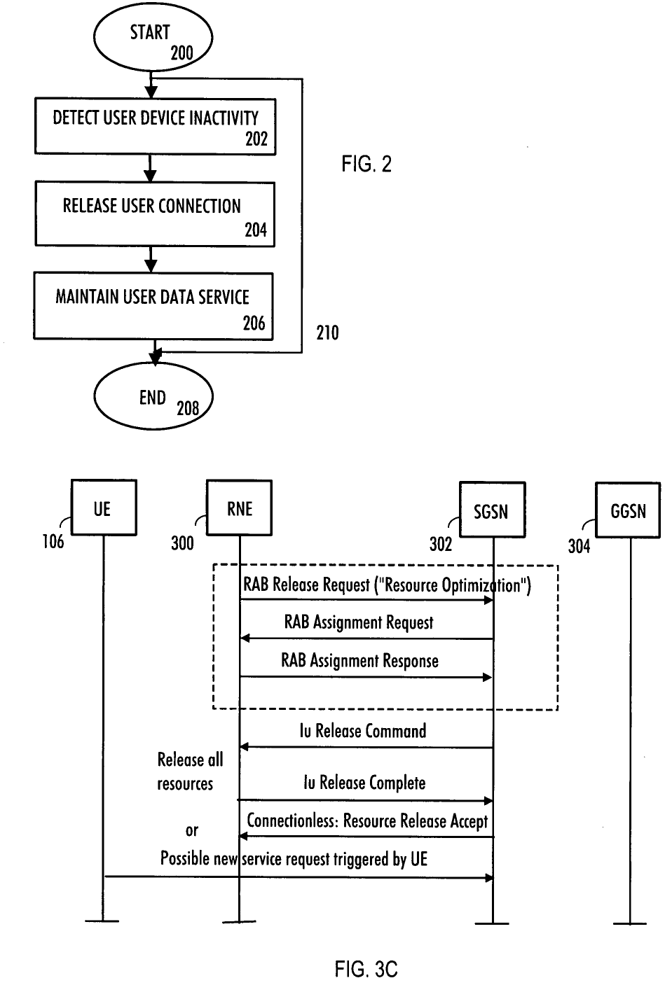

In the following, an embodiment of the data transmission method in a communication system is explained by means of FIG. 2. The embodiment starts in block 200.

In block 202, user device inactivity is detected. The process of monitoring user device activity is known to a person skilled in the art and is not explained herein in further detail. User device inactivity typically means that no data transfer exists to or from a user device.

In block 204, a user connection to a core network element is released for saving resources.

If a radio network element, typically node B (base station), a radio network controller or an element of combined functionality thereof, detects that a user device is inactive, the radio network element releases a user connection to save resources. Node B then typically informs a core network element that the user connection has been released.

The core network element may be a serving GPRS support node (SGSN) or a gateway GPRS support node (GGSN), where GPRS is an abbreviation of a general packet radio service, etc.

The GPRS Core Network provides mobility management, session management and transport for Internet Protocol packet services in Global System for Mobile Communications (GSM) and Universal Mobile Telecommunications System (UMTS) networks.

GPRS Tunneling Protocol (GTP) is an Internet protocol of the GPRS core network. It enables a user device to maintain Internet connections while moving. It conveys subscriber data from the subscriber's current SGSN to the GGSN which is handling the session.

In an embodiment, the communications system is a Universal Mobile Telecommunications System (UMTS) and the user connection is an lu connection between the radio network element and the core network element. In such a case, a Packet Data, Protocol (PDP) context may be preserved for enabling resource release in SGSN/GGSN.

A PDP context is network-level information which is used to bind a user device to various PDP addresses and to unbind the user device from these addresses after use.

PDP context activation means that an IP address is given to a user device, and other subscriber-related parameters are activated.

A PDP context refers to the information stored in the user device, in the serving GPRS support node, and in the gateway GPRS support node when a connection to an external packet data network has been activated.

When a user device is starting packet data delivery, a PDP context is activated. Stored user device data includes: IP address, Tunnel Endpoint Identifier (TEID) at the GGSN, TEID at the SGSN, for example.

In block 206, a user data service is maintained for enabling data transfer from the core network element via a radio network element to the use device.

In an embodiment, the communications system is a Universal Mobile Telecommunications System (UMTS) and the user data service is a Radio Access Bearer (RAB) and/or a Radio Resource Control (RRC) connection. In the embodiment, an RAB is typically maintained both in the radio network element and in the core network element.

When an RAB is not released, the GGSN knows the IP address and TEID of the user device, which provides means for routing downlink data to the network element enabling the user device's connection to the network.

The network element may maintain an RRC connection, in which case it can convey the data straight to the user device or it can release the RRC connection, page the user device (or request the SGSN to execute paging) and re-establish an RRC connection for data delivery.

When the user device is moving, the radio network element may update an RAB every time a serving radio network element changes. In such a case, an SGSN updates a PDP context providing a GSGN with a right address for data delivery.

Another option is that the radio network element updates RABs when required: if the user device is inactive, no RABs may be updated until downlink data for delivery is provided.

If downlink data is provided, it is typically conveyed from a SGSN or GGSN to the radio network element whose IP address the SGSN or GGSN knows (this radio network element can be called a serving radio network element. A serving radio network element is typically the network element which served the user device last time it was active). This radio network element knows the location of the user device or pages it (or the SGSN carries out paging, if it received downlink data, a short message service (SMS) message, etc.) and establishes an RRC connection or uses a maintained RRC connection and delivers the data.

It should be noticed that data can be conveyed not only via an SGSN but also via a more rapid route straight via a GGSN to a radio network element. Data delivery between a radio network element and the GGSN is called One Tunnel.

Several options exist for data delivery from a radio network element to a user device. First, the downlink data may be forwarded from a serving radio network element to a new radio network element whose coverage area the user device has entered.

Second, either the serving radio network element or the new radio network element may update user location to a core network element. The location could be updated if user device activity is noticed or even when the user device is idle.

If location update is carried out after or during data delivery, the serving radio network conveys the data to the user device until the user device's address has been changed.

The embodiment ends in block 208. The embodiment is repeatable in various ways. An alternative is shown in FIG. 2. Arrow 210 illustrates a situation where a user device is active. Another alternative is to determine inactivity and release resources; in such a case, radio resources, an RAB and/or lu connection could be released.

An example of a procedure used when a user device moves (changes from one network element to another) in the communications network is now explained.

A currently serving radio network element called an original serving radio network element releases the lu connection to a core network, but maintains the active data connection to the user device and GTP (GPRS tunneling protocol) connectivity to the GGSN.

The original serving radio network element requests a resource release (e.g. RAB Release Request with a cause “resource optimization”, or directly an lu connection release with a cause specifying that an RAB is maintained). Alternatively, a message releasing the lu connection, but maintaining the RAB may be conveyed.

The original serving SGSN may respond with a message or by sending an “lu Release Command” (with a cause indicating that RAB(s) is maintained). The original serving radio network element releases the lu connection and sends an “lu Release Complete” message to the original serving SGSN (with the cause indicating that the RABs are maintained). The original serving radio network element and the original serving SGSN knows that the RAB still exists and user data transfer may continue between the GGSN and the user device.

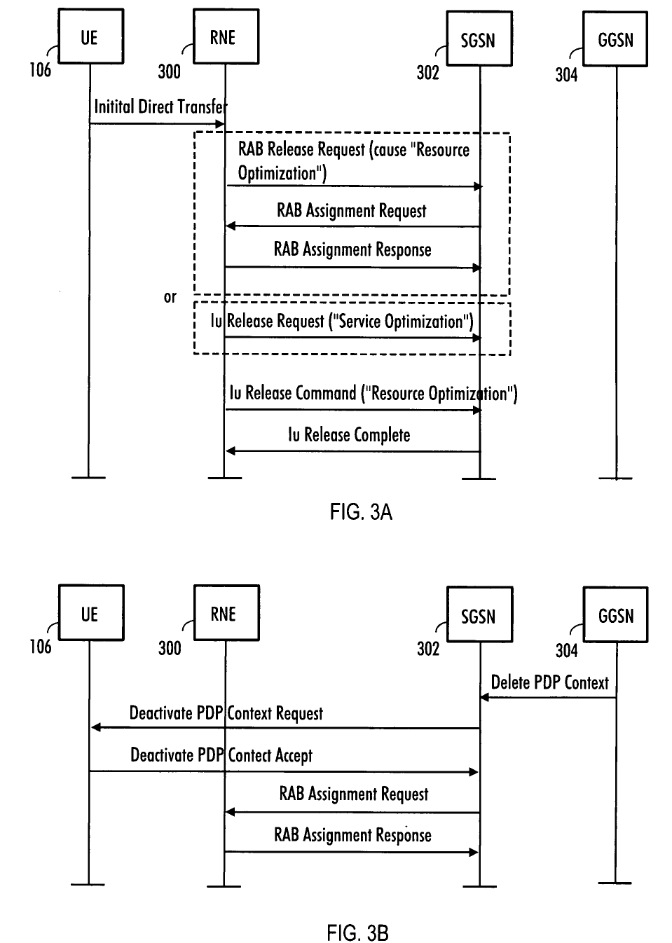

An embodiment presented in FIGS. 3A to 3D provides optimization, wherein an RAB Assignment request message may not need a response message because resources can be released without such a message, since user data transfer is not interrupted. This is because a radio access network (RAN) node can retransmit the request message, if it does not receive a response. Also a new lu connection release message can be used for indicating the above optimization. FIGS. 3A to 3D are explained below. It is obvious for a person skilled in the art that the messages presented in the Figures, are only examples for clarifying the optimization. Messaging depends on circumstances, for instance, on a current radio interface standard or, in the case of a handover, whether an inter-frequency handover or intra-frequency handover takes place.

Charging is implemented in an edge node (e.g. GGSN) according to a negotiated PDP context or application characteristics as long as a PDP context is active. If a radio network element receives error indication from the core network (GGSN) indicating that no TEID (i.e. PDP context) exists it informs the SGSN of this with an RAB (and may include the information received from a GTP error indication as a cause). The radio network element may establish an lu connection for notification if needed, but messages can be sent in connectionless manner as well.

If the GGSN receives an error indication from an RAN node indicating that no RAB exists (or indicates another error), it may update the PDP context to the SGSN (with information received from the RAN node). The SGSN may try to re-establish the RAB. If it does not succeed, the SGSN may deactivate the PDP context to the GGSN and the user device.

If the GGSN receives an error indication from an RAN node indicating that no RAB exists (or some other kind of an error has taken place), it may update the PDP context to the SGSN (with information received from the RAN). Alternatively, the GGSN may have stored SGSN GPRS Tunneling Protocol-user plane (GTP-U) endpoint information and thus can send user data to the SGSN. The SGSN is arranged to buffer data, and it re-establishes the RAB(s), if required. The GGSN may also send user data to both the RAN node and the SGSN in order to enable data transfer to recover faster. If this RAB establishment is not successful, the SGSN may deactivate the PDP context to the GGSN and to the user device.

When the resource optimization explained above by means of FIG. 2 is used, an lu connection is released and the user device moves from one UTRAN Registration Area to another, the user device may send a “CCH:URA Update” message (CCH means a Control Channel; URA means an UTRAN registration area) to the radio network element whose coverage area the user device has entered. This radio network element may be selected as a serving radio network node for the user in a URA area or, alternatively, mechanisms for balancing the load can be used in selecting the serving radio network node.

In such a case, the new serving radio network element obtains information from the original serving network element as a part of signaling. New information elements (IE), such as a user device and PDP characteristics, RAB parameters and CN addresses may be exchanged.

The radio network element updates the new user device location with an “Uplink Signaling Transfer Indication” message. The new serving radio network element (node) updates the radio network address of the user device to the core network using either connection oriented or connectionless signaling. If a connectionless manner is utilized, the new serving radio network element may use existing RANAP procedures, such as “Information Transfer Indication” or “Direct Information Transfer” or an RAB modify. A message includes an RAB ID and user device identity so that the (core network) CN node can identify the user device.

In the case of a connection-oriented manner, the update can be carried out by using an “RANAP Initial UE message” carrying a service request, an RAB update or another message. The new serving SGSN may send an “RAB Assignment Request” message to which the new serving radio network element responds by sending an “RAB Assignment Response” message including a new IP address (or acknowledges the IP address update in another manner). The new serving SGSN updates the PDP context to the GGSN. The messaging may be a “PDP Context Update” and a “PDP Context Update Response”. No relocation is required as the user is inactive.

The new serving radio network element sends a “CCH:URA Update Confirm” message to the user device which in turn sends a “DCCH: UTRAN Mobility Information Confirm” (DCCH means dedicated control channel) message to the new serving radio network element.

If the user device moves within the URA, no need to update the IP address exists, if an original serving radio network element is capable of forwarding user data to a new serving radio network element.

If data transfer is active (and the user device is e.g. in a Cell_DCH state (DCH means data channel), a relocation is performed. In other words, when a serving radio network element changes, relocation is carried out and the IP address is changed in the new serving SGSN and in the GGSN.

If relocation is performed, the original serving radio network element sends a “Relocation Required message” to the original serving SGSN, which then forwards the message to the new serving SGSN (if a node is changed). The new serving SGSN sends a “Relocation Request” message to the second radio network element. Then, radio access bearers are established in the following way:

The new serving radio network element sends a “Relocation Request Acknowledge” message to the new serving SGSN which then responds by sending a “Relocation Response” message.

The original SGSN sends a “Relocation Command” message to the original serving radio network element. The original serving radio network element forwards data and sends a “Relocation Commit” message to the new serving radio network element. The new serving radio network element sends a “Relocation Detect” message to the new serving radio network element.

The new serving radio network element sends a “Relocation Detect” message to the new serving SGSN and a “Cell Update Confirm/URA Update Confirm” or “Cell Update Confirm/GRA Update Confirm” message to the user device. The user device responds by sending an “UTRAN Mobility Information Commit” message. The new serving radio network element then sends a “Relocation Complete” message to the new serving SGSN.

The original serving SGSN sends a “Relocation Complete” message to the new serving SGSN, which then responds with a “Relocation Complete Acknowledge” message.

The new serving SGSN sends an “Update PDP Context Request” message to the GGSN, to which the GGSN responds by sending an “Update PDP Context Response” message.

The new serving SGSN sends an “lu Release Command” to the original serving radio network element which responds by sending an “lu Release Complete” message.

Then a routing area update procedure is started.

Examples of messaging while maintaining an RAB (and/or RRC connection) although an lu connection is released (maintaining Direct Tunnel, for example) and an IP address of a user device is updated are explained by means of FIGS. 3A to 3D.

It is obvious for a person skilled in the art that the messages presented in the Figures, are only examples for clarifying the optimization. Messaging depends on circumstances, for instance, on a current radio interface standard or, in the case of a handover, whether an inter-frequency handover or intra-frequency handover takes place.

FIG. 3A illustrates a user device 106, a radio network element (or an RAN node), (RNE) 300, a SGSN 302, and a GGSN 304. FIG. 3A depicts a procedure for establishing an RRC connection.

First, the user device sends an initial direct transfer message to the RNE. The user device has a PDP context, or otherwise the IU connection is released.

Optimization is activated and the, currently serving radio network element RNE 300 releases the lu connection to a core network, but maintains an active data connection to the user device 106 and GTP (GPRS tunneling protocol) connectivity to the GGSN 304.

The radio network element requests resource release (e.g. an RAB Release Request with a cause “resource optimization” (or directly lu connection release with a cause specifying that an RAB is maintained). Alternatively, a message releasing the lu connection while maintaining an RAB may be conveyed.

The SGSN sends the RNE an “RAB Assignment Request” message and the RNE responds with an “RAB Assignment Response” message. Another option is that the RNE sends an “lu Release Request” message including a cause “Service Optimization” to the SGSN. The SGSN sends an “lu Release Command” including a cause “Resource Optimization”, to which the RNE responds by sending an “lu Release Complete” message.

Both the RNE and the SGSN see the RABs and the lu connection as released for resource saving but, in reality, the RABs are maintained and thus a user connection exists between the RNE (RAN node) and the SGSN or GGSN. As a result, a user data session is active between the user device and the GGSN and user data transfer may continue.

FIG. 3B illustrates an example of PDP context deactivation, for example due to an error indication received in GTP.

In this example, a user data session is optimized and active between the user device and the GGSN. No lu connection in the SGSN is provided.

FIG. 3B illustrates a user device 106, a radio network element (or an RAN node), (RNE) 300, a SGSN 302, and a GGSN 304.

First, the GGSN sends a “Delete PDP Context” message.

The SGSN may page the user device, which then responds by sending a service request (or by another message) to set up an lu connection with the RAN node, since the user device has an RRC connection with the RNE. Thus the SSGN assumes that an lu connection exists. The SGSN may send a new connectionless message to the RAN node to request establishment, or the RAN node may respond to the paging without actually paging the user device.

The SGSN sends the user device a “Deactivate PDP Context Request” message, to which the user device responds by sending a “Deactivate PDP Context Accept” message.

The SGSN sends an “RAB Assignment Request” message to the RNE to which the RNE responds with an “RAB Assignment Response” message. The PDP context and/or an lu connection are released.

Since the RAN node (RNE) knows that this is the last release of an RAB in the procedure, no special cause is informed. The RAN node may release the RRC connection and/or request an lu release after the RAB release.

Charging is implemented in the edge node (e.g. the GGSN) according to a negotiated PDP context or application characteristics as long as a PDP context is active. If the radio network element receives error indication from the core network (the GGSN) indicating that no TEID (i.e. the PDP context) exists it informs the SGSN of this with an RAB (and may include the information received from a GTP error indication as a cause). The radio network element may establish an lu connection as a notification, if required, but messages can be sent in a connectionless manner as well.

If the GGSN receives an error indication from the RAN node indicating that no RAB exists, it may update the PDP context to the SGSN (with information received from the RAN node). The SGSN can try to re-establish an RAB. If it does not succeed, the SGSN may deactivate the PDP context to the GGSN and the user device.

FIG. 3C depicts an example of a procedure for a case when an RAN node releases an optimized connection.

FIG. 3C illustrates a user device 106, a radio network element (or an RAN node), (RNE) 300, a SGSN 302, and a GGSN 304.

Data transmission is ongoing between the user device and the GGSN via the RAN node, but no lu connection exists, i.e. an optimization routine is possible.

In the case of GTP-U error indication or internal error, etc., the RAN node may release requests.

The RAN node may send an “RAB release Request” message including a cause “resource optimization”, to which the SGSN responds by sending an “RAB Assignment Request” message. Then, the RAN node sends an “RAB Assignment Response” message.

Further, the SGSN sends an “lu Release Command” to the RAN node and the RAN node responds with an “lu Release Complete” message after it has released resources.

Another option is that the SGSN sends a connectionless message “Resource release Accept”.

If the user device sends new service requests, new resources may be established.

FIG. 3D illustrates a user device 106, a first radio network element (or an RAN node), (RNE) 300, a SGSN 302, a GGSN 304, and a second radio network element 306.

In FIG. 3D, data transmission is ongoing between the user device 106 and the GGSN 304 via the RAN node 1 300. No lu connection exists, i.e. optimization is possible. The user device moves from the RAN node 1 300 to the RAN node 2 306. The RAN nodes exchange necessary parameters. Relocation is commanded similarly to the intra RNC soft handover via an lur connection.

The example depicted in FIG. 3D is a case wherein the RAN node is changed with no a need to update the change to the SGSN 302, since no lu connection exists. In such a case, the RAN node can directly update its IP address to the GGSN by sending an “update PDP context request message”. The GGSN responds and the update can be marked as a direct update. A direct update is possible as long as the RAN node is controlled by the same SGSN.

If the RAN node is located in the same URA (a core network node also knows all RAN nodes in the URA area), it can exchange handover parameters with other RAN nodes (e.g. via an lur interface). Typically, the parameters to be exchanged are about the same as those used in relocation, see e.g. 3GPP 25.413 chapter 9.2.1.28 Source RNC to Target RNC Transparent Container) which is incorporated herein as reference.

Since the SGSN has lost the user device's location in the URA area, it typically pages the user device, if an lu connection is required.

The optimization removes the need for the SGSN to be a part of a user plane processing and signaling (at least when no lu connection exists). This alternative requires a GGSN control plane address to be provided to the RAN node in an RAB assignment phase. Also the GGSN should be configured to allow PDP updates from elsewhere than an SGSN control plane endpoint. An alternative could be that the SGSN forwards a PDP update message to the GGSN.

To further optimize data transmission, a source RAN node may forward data received from the GGSN to the target RAN node.

This option also suits for cases where user data transmission is not active. User data transmission can start immediately since the GGSN always has a correct GTP-U endpoint (an RAN node maintains an RRC connection to be able to resume data transmission).

If the GGSN receives an error indication, it can request the SGSN to re-establish an RAB. If the GGSN receives a PDP update message marked as a “direct update”, it can request the SGSN to page the user device before an RAB assignment (the user device may have changed its RAN node).

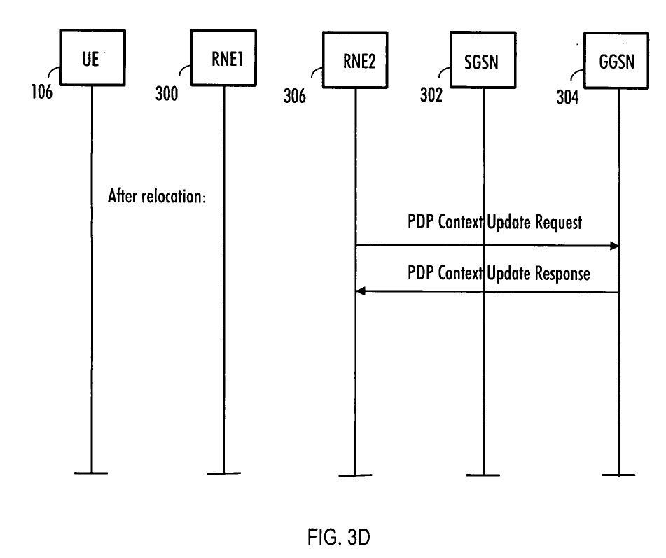

Referring to FIG. 4, a simplified block diagram illustrates an example of a logical structure of a radio network element. A radio network element is an example of an apparatus arranged to carry out embodiments of the method described above.

The communications network may include separate base stations and radio network controllers, but in this example the functionality of a conventional base station and a radio network controller are integrated to one unit.

The radio network element is the switching and controlling element of UTRAN, but embodiments may also be applied into SAE/LTE (Long Term Evolution (LTE), System Architecture Evolution (SAE)) or other radio access networks. In SAE/LTE, a radio network node is called eNB. The core network architecture is split into Mobility Management Entity (MME) and a User Plane Entity (UPE) functionalities and 3GPP anchor nodes.

Switch 400 takes care of connections between the core network and the user device. The radio network element is located between Uu 402 and lu 414 interfaces. The radio network element is connected to these interfaces via interface units 404, 412. There is also an interface for inter-radio network element transmission, called lur 416.

The functionality of the radio network element can be classified into UTRAN radio resource management 406 and control functions 410. An operation and management interface function 408 serves as a medium for information transfer to and from management functions.

Radio resource management is a group of algorithms for sharing and managing a radio path connection so that the quality and capacity of the connection are adequate. The radio resource management also carries out functions needed for transmitting and receiving radio signals, such as radio frequency and base band functions.

UTRAN control functions take care of functions related to set-up, maintenance and release of a radio connection between the radio network element and user devices.

Embodiments of the optimization method described above may be carried out in the switching, radio resource management and control functions.

The precise implementation of the radio network element is vendor-dependent.

The embodiments may be implemented as a computer program comprising instructions for executing a computer process of detecting user device inactivity, releasing a user connection to a core network element for saving resources and maintaining a user data service for enabling data transfer from the core network element via a radio network element to a use device.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

The techniques described herein may be implemented by various means. For example, these techniques may be implemented in hardware (one or more devices), firmware (one or more devices), software (one or more modules), or combinations thereof. For a hardware implementation, the processing units used for channel estimation may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For a firmware or software, implementation can be through modules (e.g., procedures, functions, and so on) that perform the functions described herein. The software codes may be stored in memory unit and executed by the processors. The memory unit may be implemented within the processor or external to the processor, in which case it can be communicatively coupled to the processor via various means as is known in the art. Additionally, components of systems described herein may be rearranged and/or complimented by additional components in order to facilitate achieving the various aspects, goals, advantages, etc., described with regard thereto, and are not limited to the precise configurations set forth in a given figure, as will be appreciated by one skilled in the art.

Even though the invention has been described above with reference to an example according to the accompanying drawings, it is clear that the invention is not restricted thereto but it can be modified in several ways within the scope of the appended claims.

1. A method comprising,
detecting user device inactivity in a communications system;
releasing a user connection to a core network element for saving resources; and
maintaining a user data service for enabling data transfer from the core network element via a radio network element to a user device.

2. The method of claim 1, further comprising forwarding downlink data from a first radio network element to a second radio network element for adapting data transfer to a user device's changed location.

3. The method of claim 1, further comprising updating an Internet address of the user device when the user device changes from a first radio network element to a second radio network element.

4. The method of claim 1, further comprising forwarding downlink data from a first radio network element to a second radio network element for adapting data transfer to a user device location and updating an Internet address of the user device when the user device changes from a first radio network element to a second radio network element.

5. The method of claim 1, wherein the communications system is a Universal Mobile Telecommunications System and the user connection is an lu connection between the radio network element and the core network element.

6. The method of claim 1, wherein the communications system is a Universal Mobile Telecommunications System and the user data service is a Radio Access Bearer.

7. The method of claim 1, wherein the communications system is a Universal Mobile Telecommunications System and the user data service is a Radio Access Bearer and a Radio Resource Control connection.

8. The method of claim 1, wherein the communications system is a Universal Mobile Telecommunications System, the user connection is an lu connection between the radio network element and the core network element, and the user data service is a Radio Access Bearer.

9. The method of claim 1, wherein the communications system is a Universal Mobile Telecommunications System, the user connection is an lu connection between the radio network element and the core network element, and the user data service is a Radio Access Bearer and a Radio Resource Control connection.

10. The method of claim 1, wherein the communications system is a Universal Mobile Telecommunications System, the user connection is an lu connection between the radio network element and the core network element, and the maintained user data service includes an active data connection between the user device and a general packet radio service tunneling protocol connectivity to the core network.

11. An apparatus configured to:
detect user device inactivity in a communications system;
release a user connection to a core network element for saving resources; and
maintain a user data service for enabling data transfer from the core network element via a radio network element to a user device.

12. The apparatus of claim 11, further configured to forward downlink data from a first radio network element to a second radio network element for adapting data transfer to a user device's changed location.

13. The apparatus of claim 11, further configured to update an Internet address of the user device when the user device changes from a first radio network element to a second radio network element.

14. The apparatus of claim 11, further configured to forward downlink data from a first radio network element to a second radio network element for adapting data transfer to a user device location and updating an Internet address of the user device when the user device changes from a first radio network element to a second radio network element.

15. The apparatus of claim 11, wherein the communications system is a Universal Mobile Telecommunications System and the user connection is an lu connection between the radio network element and the core network element.

16. The apparatus of claim 11, wherein the communications system is a Universal Mobile Telecommunications System and the user data service is a Radio Access Bearer.

17. The apparatus of claim 11, wherein the communications system is a Universal Mobile Telecommunications System and the user data service is a Radio Access Bearer and a Radio Resource Control connection.

18. The apparatus of claim 11, wherein the communications system is a Universal Mobile Telecommunications System, the user connection is an lu connection between the radio network element and the core network element, and the user data service is a Radio Access Bearer.

19. The apparatus of claim 11, wherein the communications system is a Universal Mobile Telecommunications System, the user connection is an lu connection between the radio network element and the core network element, and the user data service is a Radio Access Bearer and a Radio Resource Control connection.

20. The apparatus of claim 11, wherein the communications system is a Universal Mobile Telecommunications System, the user connection is an lu connection between the radio network element and the core network element, and the maintained user data service includes an active data connection between the user device and a general packet radio service tunneling protocol connectivity to the core network.

21. A system configured to:
detect user device inactivity;
release a user connection to a core network element for saving resources; and
maintain a user data service for enabling data transfer from the core network element via a radio network element to a user device.

22. The system of claim 21, wherein the system is a Universal Mobile Telecommunications System, the user connection is an lu connection between the radio network element and the core network element, and the maintained user data service includes an active data connection between the user device and a general packet radio service tunneling protocol connectivity to the core network.

23. An apparatus, comprising:
means for detecting user device inactivity in a communications system;
means for releasing a user connection to a core network element for saving resources; and
means for maintaining a user data service for enabling data transfer from the core network element via a radio network element to a user device.

24. A system, comprising:
means for detecting user device inactivity;
means for releasing a user connection to a core network element for saving resources; and
means for maintaining a user data service for enabling data transfer from the core network element via a radio network element to a user device.

25. A computer program product encoding a computer program of instructions for executing a computer process for data transmission, the process comprising:
detecting user device inactivity in a communications system;
releasing a user connection to a core network element for saving resources; and
maintaining a user data service for enabling data transfer from the core network element via a radio network element to a user device.

26. The computer program product of claim 25, further comprising forwarding downlink data from a first radio network element to a second radio network element for adapting data transfer to a user device's changed location.

27. The computer program product of claim 25, further comprising updating an Internet address of the user device when the user device changes from a first radio network element to a second radio network element.

28. The computer program product of claim 25, further comprising forwarding downlink data from a first radio network element to a second radio network element for adapting data transfer to a user device location and updating an Internet address of the user device when the user device changes from a first radio network element to a second radio network element.

29. The computer program product of claim 25, wherein the communications system is a Universal Mobile Telecommunications System and the user connection is an lu connection between the radio network element and the core network element.

30. The computer program product of claim 25, wherein the communications system is a Universal Mobile Telecommunications System and the user data service is a Radio Access Bearer.

31. The computer program product of claim 25, wherein the communications system is a Universal Mobile Telecommunications System and the user data service is a Radio Access Bearer and a Radio Resource Control connection.

32. The computer program product of claim 25, wherein the communications system is a Universal Mobile Telecommunications System, the user connection is an lu connection between the radio network element and the core network element, and the user data service is a Radio Access Bearer.

33. The computer program product of claim 25, wherein the communications system is a Universal Mobile Telecommunications System, the user connection is an lu connection between the radio network element and the core network element, and the user data service is a Radio Access Bearer and a Radio Resource Control connection.

34. The computer program product of claim 25, wherein the communications system is a Universal Mobile Telecommunications System, the user connection is an lu connection between the radio network element and the core network element, and the maintained user data service includes an active data connection between the user device and a general packet radio service tunneling protocol connectivity to the core network.

35. A computer program distribution medium readable by a computer and encoding a computer program of instructions for executing a computer process for data transmission, the process comprising:
detecting user device inactivity;
releasing a user connection to a core network element for saving resources; and
maintaining a user data service for enabling data transfer from the core network element via a radio network element to a user device.

36. The computer program distribution medium of claim 35, the distribution medium including at least one of the following media: a computer readable medium, a program storage medium, a record medium, a computer readable memory, a computer readable software distribution package, a computer readable signal, a computer readable telecommunications signal, and a computer readable compressed software package.
